(19) United States
(12) Patent Application Publication
(10) Pub. No.: US 2023/0009200 A1
(43) Pub. Date: Jan. 12, 2023

(54) ANTI-POWER ENVIRONMENT SUPPRESSION CIRCUIT, TOUCH SCREEN, AND TOUCH DISPLAY DEVICE

(71) Applicants: BEIJING BOE DISPLAY TECHNOLOGY CO., LTD., Beijing (CN); BOE TECHNOLOGY GROUP CO., LTD., Beijing (CN)

(72) Inventors: Jianting WANG, Beijing (CN); Jieqiong WANG, Beijing (CN); Liping LEI, Beijing (CN); Ying XING, Beijing (CN); Cuilan HUANG, Beijing (CN)

(73) Assignees: BEIJING BOE DISPLAY TECHNOLOGY CO., LTD., Beijing (CN); BOE TECHNOLOGY GROUP CO., LTD., Beijing (CN)

(21) Appl. No.: 17/783,846

(22) PCT Filed: Jun. 10, 2021
(86) PCT No.: PCT/CN2021/099391

§ 371 Date: Jun. 9, 2022

(30) Foreign Application Priority Data
Jul. 22, 2020 (CN) 202010712548.4

(51) Int. Cl. H02J 3/01; H02M 1/12; H02M 1/44; G06F 3/044; G06F 3/041

(52) U.S. Cl. CPC H02J 3/01; H02M 1/126; H02M 1/123; H02M 1/44; G06F 3/044; G06F 3/0412; G06F 3/0418

(57) ABSTRACT

An anti-power environment suppression circuit includes: a power input terminal configured to receive an alternating current input from an external power source; a power output terminal configured to output the alternating current that has undergone anti-interference processing; a live wire, a neutral wire and a ground wire that are coupled in parallel between the power input terminal and the power output terminal; and a common-mode suppression sub-circuit coupled in the ground wire. The common-mode suppression sub-circuit is further coupled to the live wire and the neutral wire, and the common-mode suppression sub-circuit is configured to suppress common-mode interference between the ground wire and the live wire, and suppress common-mode interference between the ground wire and the neutral wire, so as to perform the anti-interference processing on the input alternating current.

### CROSS-REFERENCE TO RELATED APPLICATIONS

This application is a national phase entry under 35 USC 371 of International Patent Application No. PCT/CN2021/099391, filed on Jun. 10, 2021, which claims priority to Chinese Patent Application No. 202010712548.4 filed on Jul. 22, 2020, which are incorporated herein by reference in their entirety.

### TECHNICAL FIELD

The present disclosure relates to the field of touch technologies, and in particular, to an anti-power environment suppression circuit, a touch screen, and a touch display device.

### BACKGROUND

In the field of capacitive touch display, for capacitive touch display devices such as interactive white boards and capacitive touch digital signages, a touch position is sensed by capturing weak capacitance change of a touch screen of the capacitive touch display device. These products are powered by alternating current, and are vulnerable to interference from the alternating current input into the products, which results in misreport. Therefore, the capacitive touch display device has higher requirements on a power environment.

### SUMMARY

In an aspect, an anti-power environment suppression circuit is provided. The anti-power environment suppression circuit includes: a power input terminal, a power output terminal, a live wire, a neutral wire and a ground wire, and a common-mode suppression sub-circuit. The power input terminal is configured to receive an alternating current input from an external power source. The power output terminal is configured to output the alternating current that has undergone anti-interference processing. The live wire, neutral wire and ground wire are coupled in parallel between the power input terminal and the power output terminal. The common-mode suppression sub-circuit is coupled in the ground wire, and is further coupled to the live wire and the neutral wire. The common-mode suppression sub-circuit is configured to suppress common-mode interference between the ground wire and the live wire, and suppress common-mode interference between the ground wire and the neutral wire, so as to perform the anti-interference processing on the input alternating current.

In some embodiments, the common-mode suppression sub-circuit includes at least one common-mode suppression component. A common-mode suppression component includes a common-mode inductor, a first Y-type filter capacitor and a second Y-type filter capacitor. The common-mode inductor is coupled in the ground wire. An end of the first Y-type filter capacitor is coupled to the ground wire, and another end of the first Y-type filter capacitor is coupled to the live wire. An end of the second Y-type filter capacitor is coupled to the ground wire, and another end of the second Y-type filter capacitor is coupled to the neutral wire.

In some embodiments, an inductance of the common-mode inductor is in a range from 1 μH to 30 μH, inclusive; and a capacitance of the first Y-type filter capacitor is equal to a capacitance of the second Y-type filter capacitor.

In some embodiments, in a case where the common-mode suppression sub-circuit includes a plurality of common-mode suppression components, the plurality of common-mode suppression components are connected in series.

In some embodiments, the anti-power environment suppression circuit further includes a differential-mode suppression sub-circuit coupled in the live wire and the neutral wire. The differential-mode suppression sub-circuit is configured to suppress differential-mode interference between the live wire and the neutral wire, so as to perform the anti-interference processing on the input alternating current.

In some embodiments, the differential-mode suppression sub-circuit includes at least one differential-mode suppression component. A differential-mode suppression component includes a first differential-mode inductor, a second differential-mode inductor and an X-type filter capacitor. The first differential-mode inductor is coupled in the live wire. The second differential-mode inductor is coupled in the neutral wire. An end of the X-type filter capacitor is coupled to the live wire, and another end of the X-type filter capacitor is coupled to the neutral wire.

In some embodiments, an inductance of the first differential-mode inductor is equal to an inductance of the second differential-mode inductor; and a capacitance of the X-type filter capacitor is in a range from 0.08 μF to 0.12 μF, inclusive.

In some embodiments, in a case where the differential-mode suppression sub-circuit includes a plurality of differential-mode suppression components, the plurality of differential-mode suppression components are connected in series.

In another aspect, a touch screen is provided. The touch screen includes: a touch panel, a power supply circuit, an alternating current input interface, and the anti-power environment suppression circuit described in any of the above embodiments. The power supply circuit is disposed on a non-sensing layer of the touch panel, and the power supply circuit is coupled to the touch panel. The anti-power environment suppression circuit is disposed on the non-sensing layer of the touch panel, the power input terminal of the anti-power environment suppression circuit is coupled to the alternating current input interface through a portion of another live wire, a portion of another neutral wire and a portion of another ground wire, and the power output terminal of the anti-power environment suppression circuit is coupled to the power supply circuit through another portion of the another live wire, another portion of the another neutral wire and another portion of the another ground wire.

In some embodiments, the touch screen further includes a touch driver chip, the touch driver chip is coupled to the touch panel and the power supply circuit.

In yet another aspect, a touch display device is provided. The touch display device includes a display screen and the touch screen as described above, the touch screen and the display screen are stacked.

In some embodiments, the touch display device is a liquid crystal display; or the touch display device is an electroluminescent display device or a photoluminescent display device.

In some embodiments, the common-mode inductor, the first Y-type filter capacitor, the second Y-type filter capacitor, the first differential-mode inductor, the second differential-mode inductor, the X-type filter capacitor, the power input terminal and the power output terminal are integrated on a circuit board.

### BRIEF DESCRIPTION OF THE DRAWINGS

In order to describe technical solutions in the present disclosure more clearly, accompanying drawings to be used in some embodiments of the present disclosure will be introduced briefly below. However, the accompanying drawings to be described below are merely accompanying drawings of some embodiments of the present disclosure, and a person of ordinary skill in the art may obtain other drawings according to these drawings. In addition, the accompanying drawings in the following description may be regarded as schematic diagrams, and are not limitations on actual sizes of products, actual processes of methods and actual timings of signals involved in the embodiments of the present disclosure.

FIG. 1 is a structural diagram of a capacitive touch display panel, in accordance with some embodiments;

FIG. 2 is a structural diagram of an anti-power environment suppression circuit, in accordance with some embodiments;

FIG. 3 is a structural diagram of another anti-power environment suppression circuit, in accordance with some embodiments;

FIG. 4 is a structural diagram of yet another anti-power environment suppression circuit, in accordance with some embodiments;

FIG. 5 is a structural diagram of yet another anti-power environment suppression circuit, in accordance with some embodiments;

FIG. 6 is a structural diagram of yet another anti-power environment suppression circuit, in accordance with some embodiments;

FIG. 7 is a structural diagram of yet another anti-power environment suppression circuit, in accordance with some embodiments;

FIG. 8A is a structural diagram of a touch screen, in accordance with some embodiments;

FIG. 8B is a structural diagram of a touch driver chip of a touch screen, in accordance with some embodiments;

FIG. 9 is a structural diagram of a touch display device, in accordance with some embodiments;

FIG. 10 is a structural diagram of another touch display device, in accordance with some embodiments;

FIG. 11 is a structural diagram of yet another touch display device, in accordance with some embodiments;

FIG. 12 is a structural diagram of yet another touch display device, in accordance with some embodiments;

FIG. 13 is a structural diagram of yet another touch display device, in accordance with some embodiments;

FIG. 14 is a structural diagram of yet another touch display device, in accordance with some embodiments; and

FIG. 15 is a structural diagram of another touch screen, in accordance with some embodiments.

### DETAILED DESCRIPTION

Technical solutions in some embodiments of the present disclosure will be described clearly and completely below with reference to the accompanying drawings. However, the described embodiments are merely some but not all embodiments of the present disclosure. All other embodiments obtained by a person of ordinary skill in the art based on the embodiments of the present disclosure shall be included in the protection scope of the present disclosure.

Unless the context requires otherwise, throughout the description and the claims, the term “comprise” and other forms thereof such as the third-person singular form “comprises” and the present participle form “comprising” are construed in an open and inclusive meaning, i.e., “including, but not limited to”. In the description of the specification, terms such as “one embodiment”, “some embodiments”, “exemplary embodiments”, “an example”, “a specific example” or “some examples” are intended to indicate that specific features, structures, materials, or characteristics related to the embodiment(s) or example(s) are included in at least one embodiment or example of the present disclosure. Schematic representations of the above terms do not necessarily refer to the same embodiment(s) or example(s). In addition, the specific features, structures, materials or characteristics may be included in any one or more embodiments or examples in any suitable manner.

Hereinafter, the terms such as “first” and “second” are used for descriptive purposes only, and are not to be construed as indicating or implying relative importance or implicitly indicating the number of indicated technical features. Thus, a feature defined with “first” or “second” may explicitly or implicitly include one or more of the features. In the description of the embodiments of the present disclosure, the term “a plurality of”, “the plurality of” and “multiple” each mean two or more unless otherwise specified.

In the description of some embodiments, the term “coupled” and derivatives thereof may be used. For example, the term “coupled” may be used in the description of some embodiments to indicate that two or more components are in direct physical contact with each other. For another example, the term “coupled” may also mean that two or more components are not in direct contact with each other but still cooperate or interact with each other. The embodiments disclosed herein are not necessarily limited to the content herein.

As used herein, the term “if” is optionally construed as “when”, “in a case where”, “in response to determining”, or “in response to detecting”, depending on the context. Similarly, depending on the context, the phrase “if it is determined” or “if [a stated condition or event] is detected” is optionally construed as “in a case where it is determined”, “in response to determining”, “in a case where [the stated condition or event] is detected”, or “in response to detecting [the stated condition or event]”.

The phase “applicable to” or “configured to” used herein means an open and inclusive expression, which does not exclude devices that are applicable to or configured to perform additional tasks or steps.

In addition, the phase “based on” is meant to be open and inclusive, since a process, step, calculation or other action that is “based on” one or more of the stated conditions or values may, in practice, be based on additional conditions or value beyond those stated.

In the field of touch display, considering an example of capacitive touch display devices, the capacitive touch display device has higher requirements on a power environment due to the following reasons. The capacitive touch display device acquires a capacitance change amount at a touch position on a touch module, the capacitance change amount is converted into a current change amount or a voltage change amount, and positioning of the touch position is realized by a touch driver chip according to the current change amount or the voltage change amount. When a human body touches a certain position on the touch module, the capacitance change amount at the position is extremely low, which is generally between 2 pF and 4 pF, so that the capacitive touch display device is extremely vulnerable to influence from alternating current input from an outside. In addition, for a large-sized capacitive touch display device, touch electrodes and sensing electrodes have high impedances, so that the current change amount or the voltage change amount transmitted to the touch driver chip by the touch electrodes and the sensing electrodes is low. As a result, misreport or misoperation of the capacitive touch display device is prone to occur under a condition of being interfered by the power environment.

In the present disclosure, the power environment refers to electromagnetic interference (EMI) generated by other power supply electronic devices that surround a power supply electronic device (e.g., the capacitive touch display device). A harsh power environment is mainly caused by a common-mode current generated in a reference ground. In addition, interference factors include electrical fast transients, electrical surges, voltage drops, short interruptions, short-term voltage changes, alternating current harmonics, inter-harmonics, etc. For example, in a case where the capacitive touch display device and other power supply electronic devices are connected to a same power supply system, the EMI will be generated in the other power supply electronic devices, so that the alternating current output by the power supply system is polluted, resulting in unstability and other abnormal phenomena. Since the capacitive touch display device is sensitive to the power environment, touch failure may occur.

Based on this, embodiments of the present disclosure provide an anti-power environment suppression circuit, the anti-power environment suppression circuit may be applied to the capacitive touch display device. The anti-power environment suppression circuit is configured to perform anti-interference processing on an alternating current transmitted to the capacitive touch display device. Therefore, the alternating current is not interfered by the external harsh power environment, and clean power is provided for components (especially a touch screen) of the capacitive touch display device.

In addition, the anti-power environment suppression circuit may also be applied to other devices that are sensitive to the power environment.

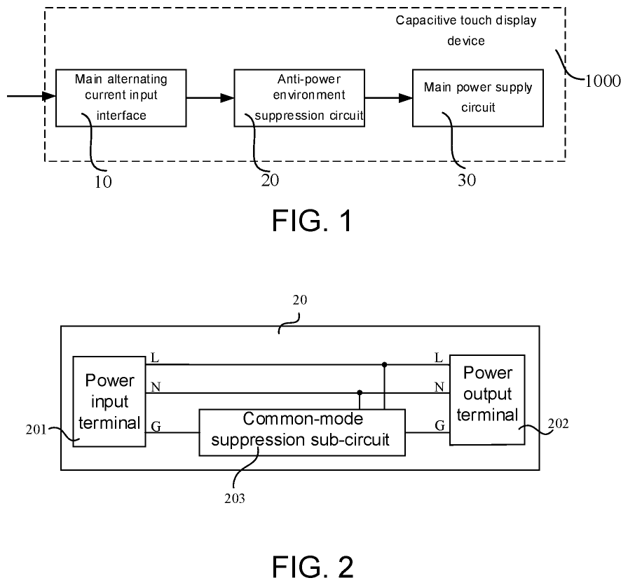

In some examples, the anti-power environment suppression circuit is disposed at an alternating current input terminal of the capacitive touch display device. For example, as shown in FIG. 1, the capacitive touch display device 1000 includes a main alternating current input interface 10, an anti-power environment suppression circuit 20, a main power supply circuit 30 and other functional components. The anti-power environment suppression circuit 20 is disposed between the main alternating current input interface 10 and the main power supply circuit 30. A current is transmitted to the main alternating current input interface 10 from an external power supply system, and after the anti-power environment suppression circuit 20 performs anti-interference processing on the current, the common-mode interference and differential-mode interference caused by an alternating current are eliminated. Then, the alternating current is transmitted to the main power supply circuit 30, and the alternating current received by the main power supply circuit 30 is clean electric power. The main power supply circuit 30 generates corresponding voltages according to the received electric power and transmits the voltages to the functional components. For example, in a case where the main power supply circuit 30 transmits a voltage to a touch module of the capacitive touch display device 1000, since the anti-power environment suppression circuit 20 has performed the anti-interference processing on the input alternating current, the alternating current finally transmitted to the touch module is the alternating current that has been eliminated external pollution, so that the capacitive touch display device 1000 will not be interfered by the power environment. As a result, misreport or misoperation is avoided, and in turn, accuracy and reliability of the capacitive touch display device 1000 are improved.

In some embodiments, in order that the alternating current has a very convenient power conversion function, a three-phase four-wire manner is taken to perform power transmission. That is, transmission wires for transmitting the alternating current include a live wire, a neutral wire and a ground wire. The main alternating current input interface 10 of the capacitive touch display device 1000 is coupled to the power supply system through a three-phase plug. In addition, the capacitive touch display device 1000 is equipped with a system ground. For example, the system ground generally refers to a ground with a large area of the capacitive touch display device 1000. In fact, a metal backplane of the capacitive touch display device 1000 is generally considered as the system ground. For example, the main alternating current input interface 10 is arranged on the metal backplane, and the system grounding is connected to a ground wire in a live wire, a neutral wire and a ground wire. The anti-power environment suppression circuit 20 includes a power input terminal and a power output terminal. The power input terminal of the anti-power environment suppression circuit is coupled to an alternating current input interface through a portion of another live wire, a portion of another neutral wire and a portion of another ground wire, and the power output terminal of the anti-power environment suppression circuit is coupled to a power supply circuit through another portion of the another live wire, another portion of the another neutral wire and another portion of the another ground wire. The ground wire in the live wire, the neutral wire and the ground wire is connected to a nearest ground point of a connection terminal of the main power supply circuit 30 to the system ground after passing through the anti-power environment suppression circuit 20.

The structure of the anti-power environment suppression circuit is described below.

It will be noted that, during the transmission of the alternating current, a differential-mode current is generated between a wire and another wire (i.e., a neutral wire and a live wire) due to the electromagnetic interference, resulting in interference (i.e., the differential-mode interference) on the load; a common-mode current is generated between a wire (e.g., the live wire) and the ground wire due to the electromagnetic interference, and a differential-mode voltage is generated on the load due to the common-mode current, resulting in interference (i.e., the common-mode interference). The differential-mode interference and the common-mode interference are both power wire noise, which may affect normal operations of the power supply electronic devices. For example, due to the differential-mode interference and the common-mode interference, normal touch functions may not be realized in the capacitive touch display device, and the misreport or misoperation may be easily occurred.

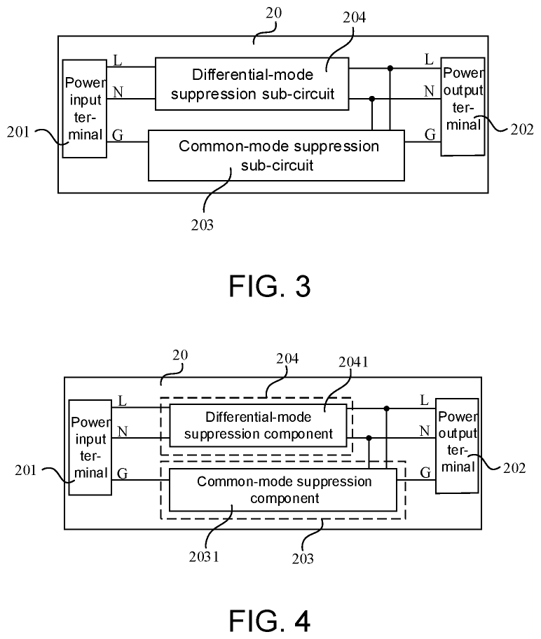

As shown in FIG. 2 and FIG. 3, the embodiments of the present disclosure provide the anti-power environment suppression circuit 20. The anti-power environment suppression circuit 20 includes: a power input terminal 201, a power output terminal 202, power transmission wires, and a common-mode suppression sub-circuit 203.

The anti-power environment suppression circuit 20 is configured to perform the anti-interference processing on the received alternating current to eliminate the influence of the external environment on the alternating current, so that the output alternating current is clean, and the anti-power environment pollution capability of the alternating current is improved.

The power input terminal 201 is configured to receive the alternating current input from an external power source; and the power output terminal 202 is configured to output the alternating current that has undergone the anti-interference processing.

The power transmission wires include a live wire L, a neutral wire N and a ground wire G that are coupled in parallel between the power input terminal 201 and the power output terminal 202.

The common-mode suppression sub-circuit 203 is coupled in the ground wire G, and the common-mode suppression sub-circuit 203 is further coupled to the live wire L and the neutral wire N. The common-mode suppression sub-circuit 203 is configured to suppress the common-mode interference between the ground wire G and the live wire L, so as to perform the anti-interference processing on the input alternating current.

It will be noted that, obvious common-mode interference exists between the ground wire G and the live wire L, which will affect the alternating current. Interference also exists between the neutral wire N and the ground wire G. In this case, the common-mode suppression sub-circuit 203 may also suppress the common-mode interference between ground wire G and neutral wire N.

As mentioned above, a main reason for the harsh power environment is the common-mode current generated in the reference ground. Therefore, in the anti-power environment suppression circuit 20, by providing the common-mode suppression sub-circuit in the ground wire G 203, the common-mode suppression sub-circuit 203 being coupled to the live wire L and the neutral wire N, it may be possible to suppress the common-mode interference between the ground wire G and the live wire L and the common-mode interference between the ground wire G and the neutral wire N, so as to perform the anti-interference processing on the alternating current. As a result, the alternating current output by the power output terminal 202 is protected from the interference of the external power environment.

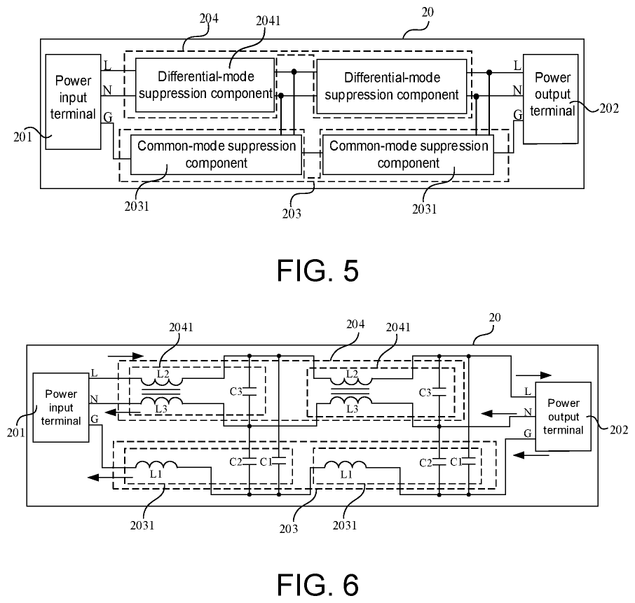

In some embodiments, referring to FIGS. 4 and 5, the common-mode suppression sub-circuit 203 includes at least one common-mode suppression component 2031. For example, as shown in FIG. 4, the common-mode suppression sub-circuit 203 includes one common-mode suppression component 2031; alternatively, the common-mode suppression sub-circuit 203 includes multiple common-mode suppression components 2031. In the case where the common-mode suppression sub-circuit 203 includes the common-mode suppression components 2031, the common-mode suppression components 2031 are connected in series. As shown in FIG. 5, the common-mode suppression sub-circuit 203 includes two common-mode suppression components 2031, and the two common-mode suppression components 2031 are connected in series.

Alternatively, the common-mode suppression sub-circuit 203 may include three common-mode suppression components 2031, and the three common-mode suppression components 2031 are connected in series.

For example, as shown in FIG. 6, the common-mode suppression component 2031 includes: a common-mode inductor L1, a first Y-type filter capacitor C1 and a second Y-type filter capacitor C2.

The common-mode inductor L1 is coupled in the ground wire G. That is, two ends of the common-mode inductor L1 are coupled to two portions of the ground wire G, respectively.

An end of the first Y-type filter capacitor C1 is coupled to the ground wire G, and another end of the first Y-type filter capacitor C1 is coupled to the live wire L.

An end of the second Y-type filter capacitor C2 is coupled to the ground wire G, and another end of the second Y-type filter capacitor C2 is coupled to the neutral wire N.

In the common-mode suppression component 2031, the common-mode inductor L1 is also referred to as a common-mode choke. The common-mode inductor L1 is capable of filtering the electromagnetic interference, and is used for suppressing outward radiation of electromagnetic waves generated by high-speed signal lines.

The Y-type filter capacitor is also referred to as a line-to-ground capacitor. That is, the Y-type filter capacitor is a capacitor located between a wire (e.g., the live wire L or the neutral wire N) and the ground wire G. The Y-type filter capacitor is capable of reducing generation of the electromagnetic interference to a considerable extent.

The common-mode suppression component 2031, which is composed of the common-mode inductor L1, the first Y-type filter capacitor C1 and the second Y-type filter capacitor C2, is equivalent to a filter circuit. In a case where the common-mode current is generated between the ground wire G and the live wire L (or between the ground wire G and the neutral wire N), when the common-mode current flows through a coil of the common-mode inductor L1, since the common-mode current is in the same direction, a same-direction magnetic field will be generated in the coil, and inductive reactance of the coil is increased. As a result, the coil has a high impedance, which leads to a strong damping. In this way, the common-mode current is attenuated, and thus a purpose of filtering is realized. By providing the common-mode suppression component 2031, it may be possible to control a common-mode electromagnetic interference signal in the ground wire G to be at a very low level. The common-mode suppression component 2031 may not only suppress inputting of external electromagnetic interference signals, but also attenuate electromagnetic interference signals generated during operation of the wires. Therefore, an interference intensity of the electromagnetic interference may be effectively reduced, and the filtering is realized.

In some examples, by setting an inductance of the common-mode inductor L1, and capacitances of the first Y-type filter capacitor C1 and the second Y-type filter capacitor C2 each in a respective suitable range, the common-mode interference may be suppressed to a great extent, and thus the alternating current may have a good anti-interference effect.

For example, the inductance of the common-mode inductor L1 is in a range from 1 μH to 30 μH, inclusive. For example, the inductance of the common-mode inductor L1 is 10 μH, 20 μH or 30 μH.

The capacitance of the first Y-type filter capacitor C1 is in a range from 400 pF to 600 pF, inclusive. For example, the capacitance of the first Y-type filter capacitor C1 is 470 pF, 500 pF or 600 pF. The capacitance range of the second Y-type filter capacitor C2 is in a range from 400 pF to 600 pF, inclusive. For example, the capacitance of the second Y-type filter capacitor C2 is 470 pF, 500 pF or 600 pF.

In some examples, the capacitance of the first Y-type filter capacitor C1 is equal to the capacitance of the second Y-type filter capacitor C2. For example, the capacitance of the first Y-type filter capacitor C1 and the capacitance of the second Y-type filter capacitor C2 are both 470 pF. In some other examples, the capacitance of the first Y-type filter capacitor C1 may not be equal to the capacitance of the second Y-type filter capacitor C2. For example, the capacitance of the first Y-type filter capacitor C1 is 500 pF, and the capacitance of the second Y-type filter capacitor C2 is 470 pF.

The inductance of the common-mode inductor L1, the capacitance of the first Y-type filter capacitor C1 and the capacitance of the second Y-type filter capacitor C2 each may be selected in the respective range described above according to actual needs, and the present disclosure does not limit thereto.

In some embodiments, as shown in FIG. 3, in addition to the common-mode suppression sub-circuit 203, the anti-power environment suppression circuit 20 further includes a differential-mode suppression sub-circuit 204 coupled in the live wire L and the neutral wire N. The differential-mode suppression sub-circuit 204 is configured to suppress the differential-mode interference between the live wire L and the neutral wire N, so as to perform the anti-interference processing on the input alternating current.

It will be noted that, obvious differential-mode interference exists between the neutral wire N and the live wire L, which may affect the alternating current. In the anti-power environment suppression circuit 20, by providing the differential-mode suppression sub-circuit 204 in the live wire L and the neutral wire N, it may be possible to suppress the differential-mode interference between the neutral wire N and the live wire L, so that the common-mode suppression sub-circuit 203 and the differential-mode suppression sub-circuit 204 cooperate with each other to perform the anti-interference processing on the alternating current. Thus, the alternating current anti-interference processing effect of the anti-power environment suppression circuit 20 is improved, and the alternating current output by the power output terminal 202 is further protected from the interference of the external power environment.

In some embodiments, referring to FIGS. 4 and 5, the differential-mode suppression sub-circuit 204 includes at least one differential-mode suppression component 2041. For example, as shown in FIG. 4, the differential-mode suppression sub-circuit 204 includes one differential-mode suppression component 2041; alternatively, the differential-mode suppression sub-circuit 204 may include multiple differential-mode suppression components 2041. In a case where the differential-mode suppression sub-circuit 204 includes the differential-mode suppression components 2041, the differential-mode suppression components 2041 are connected in series. As shown in FIG. 5, the differential-mode suppression sub-circuit 204 includes two differential-mode suppression components 2041, and the two differential-mode suppression components 2041 are connected in series. Alternatively, the differential-mode suppression sub-circuit 204 may include three differential-mode suppression components 2041, and the three differential-mode suppression components 2041 are connected in series.

For example, as shown in FIG. 6, the differential-mode suppression component 2041 includes: a first differential-mode inductor L2, a second differential-mode inductor L3 and an X-type filter capacitor C3.

The first differential-mode inductor L2 is coupled in the live wire L. That is, two ends of the first differential-mode inductor L2 are coupled to two portions of the live wire L, respectively. The second differential-mode inductor L3 is coupled in the neutral wire N. That is, two ends of the second differential-mode inductor L3 are coupled to two portions of the neutral wire N, respectively.

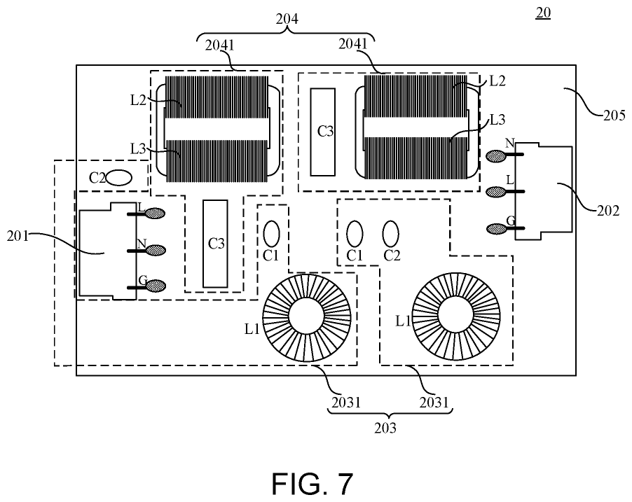

Referring to FIGS. 6 and 7, it will be noted that, the first differential-mode inductor L2 and the second differential-mode inductor L3 together have mutual inductance properties, the first differential-mode inductor L2 and the second differential-mode inductor L3 constitute a differential-mode inductor, which is capable of suppressing the differential-mode interference between the live wire L and the neutral wire N.

An end of the X-type filter capacitor C3 is coupled to the live wire L, and another end of the X-type filter capacitor C3 is coupled to the neutral wire N.

In the differential-mode suppression component 2041, the differential-mode inductor is a filter inductor capable of suppressing the differential-mode interference. The X-type filter capacitor C3 is also referred to as an across-the-line capacitor. That is, the X-type filter capacitor C3 is a capacitor located between the live wire L and the neutral wire N. The X-type filter capacitor C3 may reduce the generation of electromagnetic interference to a considerable extent.

The differential-mode suppression component 2041, which is composed of the first differential-mode inductor L2, the second differential-mode inductor L3 and the X-type filter capacitor C3, is equivalent to a filter circuit. As shown in FIG. 6, transmission directions (as shown by the arrows) of alternating currents transmitted by the neutral wire N and the live wire L are opposite. In a case where the differential-mode current is generated between the neutral wire N and the live wire L, the common-mode suppression component 2031 may effectively reduce the interference intensity of the differential-mode interference and realize filtering.

In some examples, by setting inductances of the first differential-mode inductor L2 and the second differential-mode inductor L3, and a capacitance of the X-type filter capacitor C3 each in a respective suitable range, the differential-mode interference may be suppressed to a great extent, and thus the alternating current may have a good anti-interference effect.

For example, the inductance of the first differential-mode inductor L2 is in a range from 1 μH to 30 μH, inclusive. For example, the inductance of the first differential-mode inductor L2 is 10 μH, 20 μH or 30 μH. The inductance of the second differential-mode inductor L3 is in a range from 1 pH to 30 pH, inclusive. For example, the inductance of the second-differential mode inductor L3 is 10 μH, 20 μH or 30 μH. The capacitance of X-type filter capacitor C3 is in a range from 0.08 μF to 0.12 μF, inclusive. For example, the capacitance of X-type filter capacitor C3 is 0.08 pF, 0.1 μF or 0.12 μF.

In some examples, the inductance of the first differential-mode inductor L2 is equal to the inductance of the second differential-mode inductor L3. For example, the inductance of the first differential-mode inductor L2 and the inductance of the second differential-mode inductor L3 are both 0.1 μF. In some other examples, the inductance of the first differential-mode inductor L2 may not be equal to the inductance of the second-differential mode inductor L3. For example, the inductance of the first differential-mode inductor L2 is 0.1 μF, the inductance of the second differential-mode inductor L3 is 0.12 μF.

The inductance of the first differential-mode inductor L2, the inductance of the second differential-mode inductor L3 and the capacitance of the X-type filter capacitor C3 each may be selected in the respective range described above according to actual needs, and the present disclosure does not limit thereto.

In some embodiments, as shown in FIG. 7, the common-mode inductor L1, the first Y-type filter capacitor C1 and the second Y-type filter capacitor C2 that are included in the common-mode suppression component 2031, the first differential-mode inductor L2, the second differential-mode inductor L3 and the X-type filter capacitor C3 that are included the differential-mode suppression component 2041, the power input terminal 201, and the power output terminal 202 are all integrated on a circuit board 205. For example, the circuit board 205 is a printed circuit board (PCB). The PCB is fixed in the touch display device, and is electrically connected to corresponding devices through the power input terminal 201 and the power output terminal 202, so that the anti-power environment suppression circuit 20 may perform the anti-interference processing on the alternating current transmitted to the touch display device.

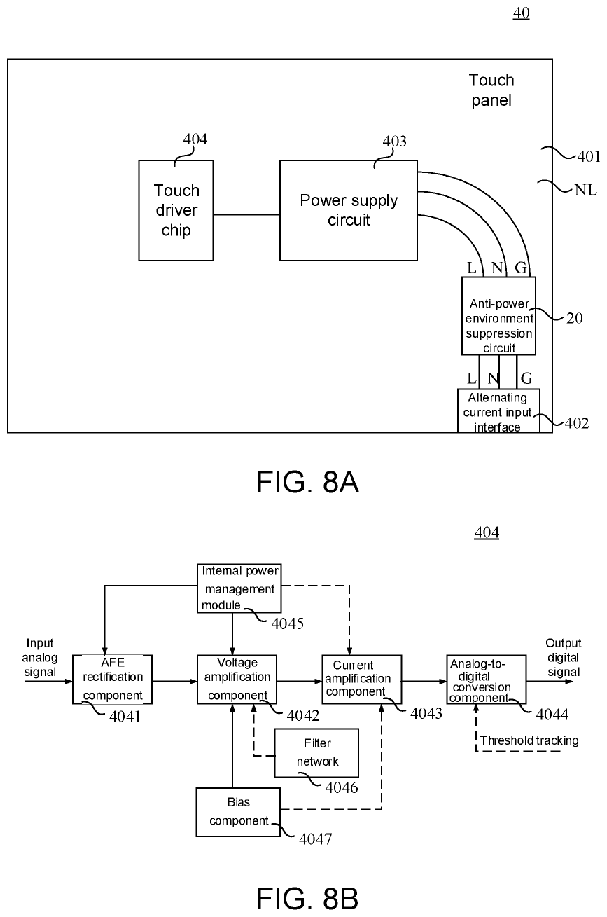

Some embodiments of the present disclosure further provide a touch screen. As shown in FIG. 8A, the touch screen 40 includes: a touch panel 401, an alternating current input interface 402, a power supply circuit 403 and the anti-power environment suppression circuit 20.

The alternating current from the power supply system is transmitted to the touch screen 40 through the alternating current input interface 402, so that the touch screen 40 is powered.

As shown in FIG. 15, the touch panel 401 has two opposite layers, i.e., a sensing layer SL and a non-sensing layer NL. The sensing layer is provided with a plurality of touch control electrodes and a plurality of sensing electrodes therein. The plurality of touch control electrodes and the plurality of sensing electrodes form a plurality of capacitors. When a human body (e.g., a finger) touches the sensing layer of the touch panel, capacitance values of capacitors corresponding to a touch position change, and thus touch control may be achieved by detecting the capacitance value change of the capacitors.

Referring to FIGS. 8A and 15, the power supply circuit 403 is disposed on the non-sensing layer NL of the touch panel 401. The power supply circuit 403 is coupled to the touch panel 401.

Referring to FIGS. 8A and 15, the anti-power environment suppression circuit 20 is disposed on the non-sensing layer NL of the touch panel 401. The power input terminal 201 of the anti-power environment suppression circuit 20 is coupled to the alternating current input interface 402 through a portion of another live wire L, a portion of another neutral wire N and a portion of another ground wire G, and the power output terminal 202 of the anti-power environmental suppression circuit 20 is coupled to the power supply circuit 403 through another portion of the another live wire L, another portion of the another neutral wire N and another portion of the another ground wire G.

The power supply circuit 403 is configured to generate a corresponding voltage according to the alternating current from the alternating current input interface 402, so as to supply power to the touch panel 401. Since the anti-power environment suppression circuit 20 is arranged between the alternating current input interface 402 and the power supply circuit 403, and the anti-power environment suppression circuit 20 is capable of performing the anti-interference processing on the alternating current transmitted to the touch screen 40 to suppress the differential-mode interference and the common-mode interference, the alternating current will not be interfered by the harsh power environment, and clean power is provided for the elements of the touch screen 40. Therefore, for the touch screen 40, the capacitance value change of the touch panel 401 may be accurately detected, which effectively improves an anti-power pollution capability of the touch screen 40. As a result, the misreport or the misoperation of the touch screen caused by the interference of the power environment is reduced.

In some embodiments, as shown in FIG. 8A, the touch screen 40 further includes a touch driver chip 404 disposed on the non-sensing layer NL of the touch panel 401, the touch driver chip 404 is coupled to the touch panel 401, and is further coupled to the power supply circuit 403.

The power supply circuit is further configured to generate a corresponding voltage according to the alternating current from the alternating current input interface 402, so as to provide power for the touch driver chip 404.

The touch driver chip 404 is configured to provide voltage signals to the plurality of touch control electrodes and the plurality of sensing electrodes of the touch panel 401, and receive voltage change or current change caused by the capacitance value change of the touch panel 401, so as to realize sensing of the touch position according to the voltage or current.

In some embodiments, as shown in FIG. 8B, the touch driver chip 404 includes an active front end (AFE) rectification component 4041, a voltage amplification component 4042, a current amplification component 4043 and an analog-to-digital conversion component 4044 that are sequentially connected in series. The touch driver chip 404 further includes an internal power management module 4045. The internal power management module 4045 is coupled to the AFE rectification component 4041, the voltage amplification component 4042 and the current amplification component 4043. The internal power management module 4045 is configured to: receive electrical energy provided by the power supply circuit 403; and according to the received electric energy, provide a reference voltage to the AFE rectification component 4041, and provide amplification voltages to the voltage amplification component 4042 and the current amplification component 4043. Thus, the AFE rectification component 4041, the voltage amplification component 4042, the current amplification component 4043 and the analog-to-digital conversion component 4044 process the received voltage or current (which is an analog signal), and the input analog signal is converted into a digital signal, and in turn, the digital signal is processed, so that the sensing of the touch position is realized.

In some examples, the touch driver chip 404 further includes a filter network 4046 and a bias component 4047. The filter network 4046 is coupled to the voltage amplification component 4042, and is configured to perform noise reduction processing on a signal output by the AFE rectification component 4041 to the voltage amplification component 4042. The bias component 4047 is coupled to the voltage amplification component 4042, and is configured to provide a bias voltage to the voltage amplification component 4042. In addition, in a process of the analog-to-digital conversion component 4044 performing signal conversion, methods such as threshold tracking are further adopted. Therefore, misreport and misoperation of products caused by the harsh power environment may be eliminated, and the reliability of the touch screen is increased.

Some embodiments of the present disclosure further provide a touch display device, the touch display device may be, for example, the capacitive touch display device 1000 shown in FIG. 1, as described above.

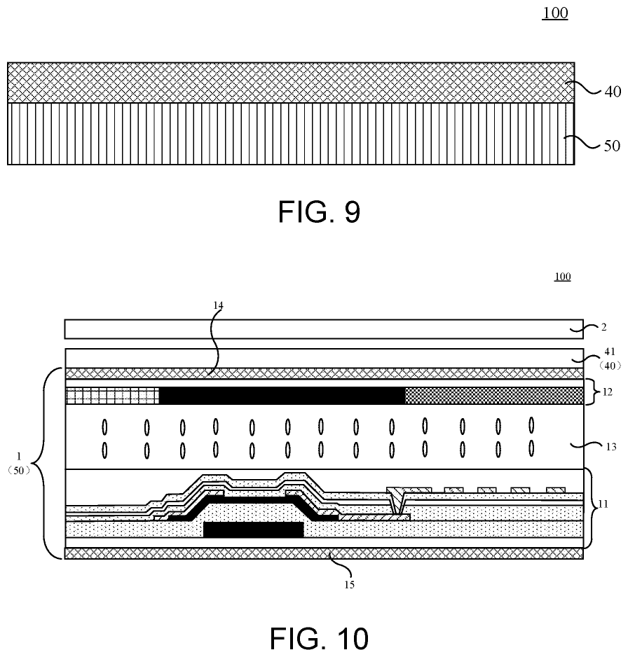

In some embodiments, as shown in FIG. 9, the touch display device 100 includes a display screen 50 and the touch screen 40. The touch screen 40 and the display screen 50 are stacked. For example, the touch screen 40 is disposed on a side of a display surface of the display screen 50, and a sensing surface of the touch screen 40 is farther away from the display screen 50 than a non-sensing surface.

Since the anti-power environment suppression circuit 20 is provided in the touch screen 40, the misreport or the misoperation of the touch screen 40 caused by the interference of the power environment may be effectively avoided, and in turn, the accuracy and reliability of the touch display device 100 are improved.

For example, the touch display device may be a liquid crystal display (LCD) device; or the touch display device may be an electroluminescent display device or a photoluminescence display device. In a case where the touch display device is the electroluminescent display device, the electroluminescent display device may be an organic light-emitting diode (OLED) display device or a quantum dot light-emitting diode (QLED) display device. In a case where the display device is the photoluminescence display device, the photoluminescence display device may be a quantum dot photoluminescence display device.

The touch display device may be a large-sized capacitive touch display device such as an interactive white board (IWB) or a capacitive touch digital signage. Alternatively, the touch display device may be a capacitive interactive display product used for navigation, medical guidance or shopping guidance.

In a case where the touch display device is the IWB, the touch display device includes: an electronic white board, a short-focus projector, a power amplifier, an audio, a computer, a video booth, a central controller, wireless headsets, a cable television and other multimedia devices. The electronic white board has an integrated structure including a display screen and a touch screen, and the multimedia devices are highly integrated as a whole.

In some embodiments, the specific stacked ways of touch screen 40 and the display screen 50 are as the following situations. The touch screen 40 and the display screen 50 may be integrated by using an out-cell technology, or may be integrated as a whole by using an on-cell technology or an in-cell technology. The touch screen 40 includes a touch structure 41, and the display screen 50 includes a display panel.

In a case where the touch display device is the liquid crystal display device, as shown in FIGS. 10 to 12, the display screen 50 includes a liquid crystal display panel 1. The liquid crystal display panel 1 includes: an array substrate 11 and an opposite substrate 14 that are opposite to each other, a liquid crystal layer 13 disposed between the array substrate 11 and the opposite substrate 14, a first polarizer 14 disposed on an outer side of the opposite substrate 12, and a second polarizer 15 disposed on an outer side of the array substrate 11. The touch display device 100 further includes a glass cover plate 2. The outer side of the opposite substrate 12 is a side thereof away from the array substrate 11, and the outer side of the array substrate 11 is a side thereof away from the opposite substrate 12.

In some examples, the touch structure 41 is disposed outside the liquid crystal display panel 1. That is, the touch structure 41 is disposed between the cover glass 2 and the first polarizer 14. In this case, the touch display device 100 is referred to as an out-cell touch display device.

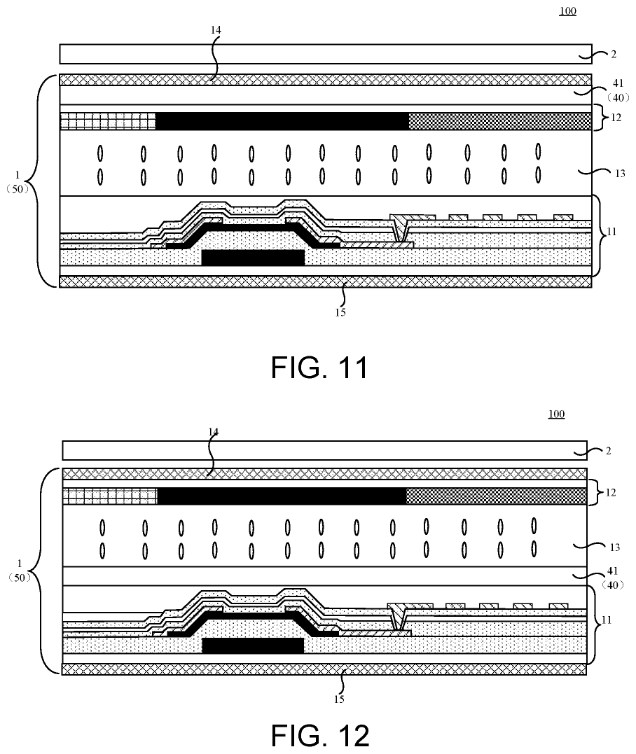

In some other examples, as shown in FIGS. 11 and 12, the touch structure 41 is disposed in the liquid crystal display panel 1. In this case, the touch display device is referred to as an in-cell touch display device. In a case where the touch structure 41 is disposed in the liquid crystal display panel 1, as shown in FIG. 11, the touch structure 41 may be disposed between the first polarizer 14 and the opposite substrate 12, and in this case, the touch display device is referred to as an on-cell touch display device; alternatively, as shown in FIG. 12, the touch structure 41 may be disposed between the array substrate 11 and the opposite substrate 12, for example, the touch structure 41 is disposed on the array substrate 11, and in this case, the touch display device is referred to as an in-cell touch display device.

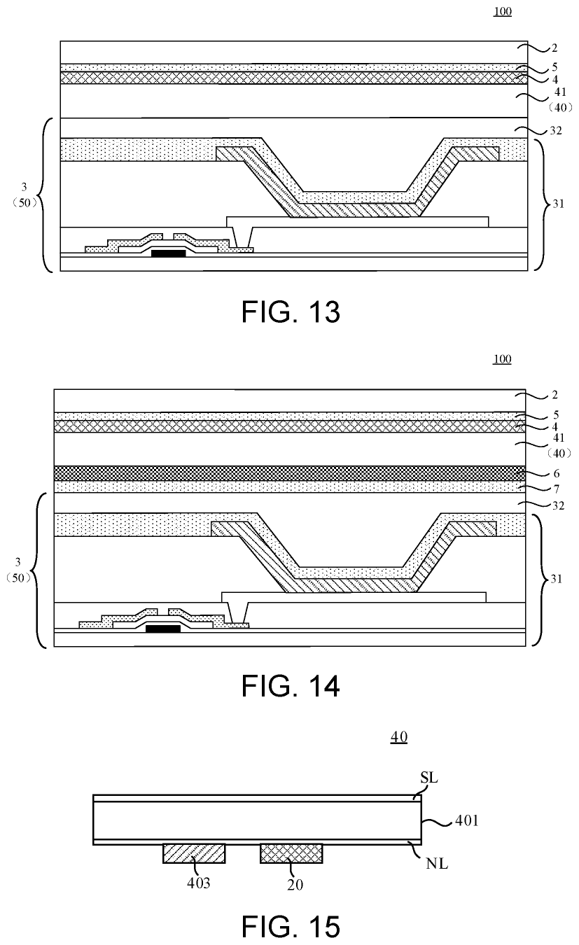

In a case where the touch display device is the electroluminescent display device or the photoluminescent display device, as shown in FIGS. 13 and 14, a main structure of the electroluminescent display device (or the photoluminescent display device) includes an electroluminescent display panel 3 (or a photoluminescent display panel 3), the touch structure 41, a polarizer 4, a first optically clear adhesive (OCA) 5 and a cover glass 2 that are sequentially arranged.

The electroluminescent display panel 3 or the photoluminescent display panel 3 includes a display substrate 31 and an encapsulation layer 32 for encapsulating the display substrate 31. Here, the encapsulation layer 32 may be an encapsulation film or an encapsulation substrate.

In some examples, as shown in FIG. 13, the touch structure 41 is directly disposed on the encapsulation layer 32. That is, there is no layer disposed between the touch structure 41 and the encapsulation layer 32. In some other examples, as shown in FIG. 14, the touch structure 41 is disposed on a substrate 6, and the substrate 6 is attached to the encapsulation layer 32 through a second optically clear adhesive 7. As shown in FIG. 13, since the touch structure 41 is directly disposed on the encapsulation layer 32, a thickness of the touch display device is low, which is conducive to realizing lightness and thinness of the touch display device.

Thus, the touch display device provided in the embodiments of the present disclosure includes the touch screen and the display screen. The touch screen is provided with the anti-power environment suppression circuit therein, and the anti-power environment suppression circuit performs the anti-interference processing on the alternating current before the alternating current is transmitted to the power supply circuit in the touch screen, which eliminates the common-mode interference and the differential-mode interference, and then the alternating current is transmitted to the power supply circuit. Therefore, the misreport of the touch screen caused by the interference of the input alternating current is avoided, and the reliability of the touch display device is improved.

The foregoing descriptions are merely specific implementations of the present disclosure, but the protection scope of the present disclosure is not limited thereto. Changes or replacements that any person skilled in the art could conceive of within the technical scope of the present disclosure shall be included in the protection scope of the present disclosure. Therefore, the protection scope of the present disclosure shall be subject to the protection scope of the claims.

1. An anti-power environment suppression circuit, comprising:
a power input terminal, the power input terminal being configured to receive an alternating current input from an external power source;
a power output terminal, the power output terminal being configured to output the alternating current that has undergone anti-interference processing;
a live wire, a neutral wire and a ground wire that are coupled in parallel between the power input terminal and the power output terminal; and
a common-mode suppression sub-circuit coupled in the ground wire, the common-mode suppression sub-circuit being further coupled to the live wire and the neutral wire, and the common-mode suppression sub-circuit being configured to suppress common-mode interference between the ground wire and the live wire, and suppress common-mode interference between the ground wire and the neutral wire, so as to perform the anti-interference processing on the input alternating current.

2. The anti-power environment suppression circuit according to claim 1, wherein the common-mode suppression sub-circuit includes at least one common-mode suppression component, wherein
a common-mode suppression component includes a common-mode inductor, a first Y-type filter capacitor and a second Y-type filter capacitor, wherein
the common-mode inductor is coupled in the ground wire;
an end of the first Y-type filter capacitor is coupled to the ground wire, and another end of the first Y-type filter capacitor is coupled to the live wire; and
an end of the second Y-type filter capacitor is coupled to the ground wire, and another end of the second Y-type filter capacitor is coupled to the neutral wire.

3. The anti-power environment suppression circuit according to claim 2, wherein
an inductance of the common-mode inductor is in a range from 1 μH to 30 μH, inclusive; and
a capacitance of the first Y-type filter capacitor is equal to a capacitance of the second Y-type filter capacitor.

4. The anti-power environment suppression circuit according to claim 2, wherein the common-mode suppression sub-circuit includes a plurality of common-mode suppression components, and the plurality of common-mode suppression components are connected in series.

5. The anti-power environment suppression circuit according to claim 1, further comprising a differential-mode suppression sub-circuit coupled in the live wire and the neutral wire, wherein
the differential-mode suppression sub-circuit is configured to suppress differential-mode interference between the live wire and the neutral wire, so as to perform the anti-interference processing on the input alternating current.

6. The anti-power environment suppression circuit according to claim 5, wherein the differential-mode suppression sub-circuit includes at least one differential-mode suppression component, wherein
a differential-mode suppression component includes a first differential-mode inductor, a second differential-mode inductor and an X-type filter capacitor, wherein
the first differential-mode inductor is coupled in the live wire;
the second differential-mode inductor is coupled in the neutral wire; and
an end of the X-type filter capacitor is coupled to the live wire, and another end of the X-type filter capacitor is coupled to the neutral wire.

7. The anti-power environment suppression circuit according to claim 6, wherein
an inductance of the first differential-mode inductor is equal to an inductance of the second differential-mode inductor; and
a capacitance of the X-type filter capacitor is in a range from 0.08 μF to 0.12 μF, inclusive.

8. The anti-power environment suppression circuit according to claim 6, wherein the differential-mode suppression sub-circuit includes a plurality of differential-mode suppression components, and the plurality of differential-mode suppression components are connected in series.

9. A touch screen, comprising:
a touch panel;
a power supply circuit disposed on a non-sensing layer of the touch panel, the power supply circuit being coupled to the touch panel;
an alternating current input interface; and
the anti-power environment suppression circuit according to claim 1, wherein the anti-power environment suppression circuit is disposed on the non-sensing layer of the touch panel, the power input terminal of the anti-power environment suppression circuit is coupled to the alternating current input interface through a portion of another live wire, a portion of another neutral wire and a portion of another ground wire, and the power output terminal of the anti-power environment suppression circuit is coupled to the power supply circuit through another portion of the another live wire, another portion of the another neutral wire and another portion of the another ground wire.

10. The touch screen according to claim 9, further comprising a touch driver chip, wherein
the touch driver chip is coupled to the touch panel and the power supply circuit.

11. A touch display device, comprising:
a display screen; and
the touch screen according to claim 9, the touch screen and the display screen being stacked.

12. The touch display device according to claim 11, wherein the touch display device is a liquid crystal display; or
the touch display device is an electroluminescent display device or a photoluminescent display device.

13. The anti-power environment suppression circuit according to claim 2, further comprising a differential-mode suppression sub-circuit coupled in the live wire and the neutral wire, wherein
the differential-mode suppression sub-circuit is configured to suppress differential-mode interference between the live wire and the neutral wire, so as to perform the anti-interference processing on the input alternating current.

14. The anti-power environment suppression circuit according to claim 13, wherein the differential-mode suppression sub-circuit includes at least one differential-mode suppression component, wherein
a differential-mode suppression component includes a first differential-mode inductor, a second differential-mode inductor and an X-type filter capacitor, wherein
the first differential-mode inductor is coupled in the live wire;
the second differential-mode inductor is coupled in the neutral wire; and
an end of the X-type filter capacitor is coupled to the live wire, and another end of the X-type filter capacitor is coupled to the neutral wire.

15. The anti-power environment suppression circuit according to claim 14, wherein the common-mode inductor, the first Y-type filter capacitor, the second Y-type filter capacitor, the first differential-mode inductor, the second differential-mode inductor, the X-type filter capacitor, the power input terminal and the power output terminal are integrated on a circuit board.

16. The touch screen according to claim 9, wherein the common-mode suppression sub-circuit includes at least one common-mode suppression component, wherein
a common-mode suppression component includes a common-mode inductor, a first Y-type filter capacitor and a second Y-type filter capacitor, wherein
the common-mode inductor is coupled in the ground wire;
an end of the first Y-type filter capacitor is coupled to the ground wire, and another end of the first Y-type filter capacitor is coupled to the live wire; and
an end of the second Y-type filter capacitor is coupled to the ground wire, and another end of the second Y-type filter capacitor is coupled to the neutral wire.

17. The touch screen according to claim 9, wherein the anti-power environment suppression circuit further includes a differential-mode suppression sub-circuit coupled in the live wire and the neutral wire, wherein
the differential-mode suppression sub-circuit is configured to suppress differential-mode interference between the live wire and the neutral wire, so as to perform the anti-interference processing on the input alternating current.

18. The touch screen according to claim 17, wherein the differential-mode suppression sub-circuit includes at least one differential-mode suppression component, wherein
a differential-mode suppression component includes a first differential-mode inductor, a second differential-mode inductor and an X-type filter capacitor, wherein
the first differential-mode inductor is coupled in the live wire;
the second differential-mode inductor is coupled in the neutral wire; and
an end of the X-type filter capacitor is coupled to the live wire, and another end of the X-type filter capacitor is coupled to the neutral wire.
